(19) United States
(12) Patent Application Publication
(10) Pub. No.: US 2018/0061406 A1
(43) Pub. Date: Mar. 1, 2018

(54) Digitalized voice guide device and a method thereof

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 15/364,500

(22) Filed: Nov. 30, 2016

(30) Foreign Application Priority Data
Aug. 26, 2016 (TW) 105127435

(51) Int. Cl. G10L 15/22; G06F 3/16

(52) U.S. Cl. CPC G10L 15/22; G10L 2015/223; G06F 3/162

(57) ABSTRACT

A digitalized voice guide device and a method thereof provided in the present disclosure are characterized that: a connecting interface of a digitalized voice guide device is inserted into a smart device's jack through which electricity is transmitted to all components on a substrate; a voice unit communicates with the smart device for signal exchange based on a acoustic mode; voice data read by the voice unit is transmitted to the smart device through the connecting interface.

### BACKGROUND OF THE INVENTION

### 1) Field of the Invention

The present disclosure relates to a device based on a smart device's voice instructions to activate a specific function and a method thereof, particularly a device which relies on a smart device's built-in connecting interface as a digital input source and features a power source as well as a distinct input procedure differing from conventional techniques.

### 2) Description of the Prior Art

Based on the philosophy of technologies always coming from human natures, the various desired functions have been brought into our lives in virtue of popularization of smart phones in which main operation systems for mobile devices such as Android and IOS created by Apple are installed.

To operate a smart phone, a touch panel interface broke the mold of human-machine interactions which relied on physical buttons originally. Furthermore, people have been expecting to interactions with machines by natural languages and embody the interactions in operation systems since the birth of the Internet of Things (IoT) and various smart phones.

As the most common tools to embody interactions with machines by natural languages, Google Now and Siri (Speech Interpretation and Recognition Interface) are familiar to users who complete interactions with mobile phones through natural conversations to search information, check weather summary, set and query a calendar on a mobile phone, set a snooze alarm, and so on.

Currently, existing applications such as querying website, checking weather summary, setting and querying calendars, and setting snooze alarms are providing more fast marketing and commercial channels to users.

### SUMMARY OF THE INVENTION

To promote applications, a digitalized voice guide device and a method thereof provided in the present disclosure rely on a smart device's built-in connecting interface as an input source, which is connected to a digitalized voice guide device for supplying electric power and opening a specific website according to a feedback voice instruction received by the smart device.

A digitalized voice guide device and a method thereof provided in the present disclosure rely on a universal connecting interface common in a device in which a specific operation system is installed to quickly and effectively access a specific website.

A digitalized voice guide device and a method thereof provided in the present disclosure send a voice instruction not heard by outsiders for privacy and safety.

A digitalized voice guide device and a method thereof provided in the present disclosure allow an online shop to promote effective internet marketing and a user, who needs not to remember any specific URL, to access and browse a specific website for follow-up internet behaviors.

To this end, a digitalized voice guide device and a method thereof are embodied with major technical measures as follows.

A digitalized voice guide device in the present embodiment comprises a connecting interface and an audio output module: the audio output module comprises a storage unit, a voice unit; the connecting interface, the storage unit and the voice unit are mounted on a substrate; the storage unit stores voice data; a digitalized voice guide device is characterized that: the connecting interface is electrically connected to a smart device's jack through which all electronic components on the substrate are electrically activated; the voice unit communicates with the smart device for signal exchange based on an acoustic mode through which voice data read by the voice unit is transmitted to the smart device.

A digitalized voice guide device and a method thereof further rely on following technical measures to realize purposes and techniques.

In the digitalized voice guide device, the connecting interface can be a USB (Universal Serial Bus) interface or a Lightning interface.

In the digitalized voice guide device, the audio output module comprises a switch mounted on the substrate.

In the digitalized voice guide device, the audio output module comprises a simulative keyboard unit installed on the substrate.

In the digitalized voice guide device, the storage unit stores input data.

In the digitalized voice guide device, the audio output module comprises a housing.

To this end, the present disclosure provides following main technical measures to realize purposes and techniques. A method of a digitalized voice guide device comprises steps as follows: step 1: a connecting interface on a digitalized voice guide device is inserted into a jack on a smart device; step 2: the connecting interface is electrically connected to the jack; step 3: electricity is transmitted to all electronic components on the digitalized voice guide device's substrate through the connecting interface; step 4: the audio output module communicates with the smart device for signal exchange based on an acoustic mode through which voice data saved in the audio output module's storage unit is read by the audio output module's voice unit; step 5: the voice data is transmitted to the smart device through the connecting interface; step 6: a specific website referring to the voice data is opened on a browser of the smart device with the voice data received by a voice assistant of the smart device.

The present disclosure further provides following steps to realize purposes and techniques.

In the method of a digitalized voice guide device, the audio output module communicates with the smart device for signal exchange based on a keyboard mode through which input data saved in the audio output module's storage unit is read by the audio output module's simulative keyboard unit after step 3.

In the method of a digitalized voice guide device, a voice assistant is activated in the smart device with the input data received by the smart device after step 3.

In the method of a digitalized voice guide device, a switch of the audio output module is pressed after step 3.

In the method of a digitalized voice guide device, the connecting interface is a USB interface or a Lightning interface.

In contrast to conventional techniques, a digitalized voice guide device and a method thereof in the present disclosure are characterized that: (1) a browse program is automatically enabled and a specific URL is entered without requirement of manual input; (2) a user, who needs not to remember any specific URL, accesses and browses a specific website for follow-up internet behaviors and an online shop promotes effective internet marketing; (3) a universal connecting interface is available without the compatibility issue.

### BRIEF DESCRIPTIONS OF THE DRAWINGS

FIG. 1a is the first block diagram illustrating a digitalized voice guide device in a preferred embodiment;

FIG. 1b is the second block diagram illustrating a digitalized voice guide device in a preferred embodiment;

FIG. 1c is a schematic view which illustrates a digitalized voice guide device is inserted into a smart device in a preferred embodiment;

FIG. 2 is the first flowchart for operation of a digitalized voice guide device in a preferred embodiment;

FIG. 3 is the second flowchart for operation of a digitalized voice guide device in a preferred embodiment;

FIG. 4 is the third flowchart for operation of a digitalized voice guide device in a preferred embodiment.

### DETAILED DESCRIPTIONS OF THE PREFERRED EMBODIMENTS

A digitalized voice guide device and a method thereof will be further illustrated in preferred embodiments for clear understanding of purposes, characteristics and effects:

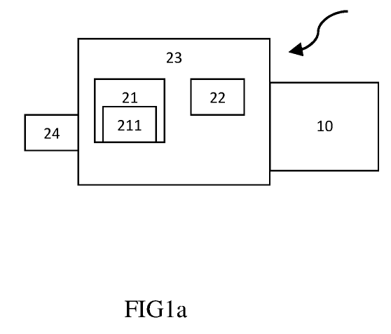

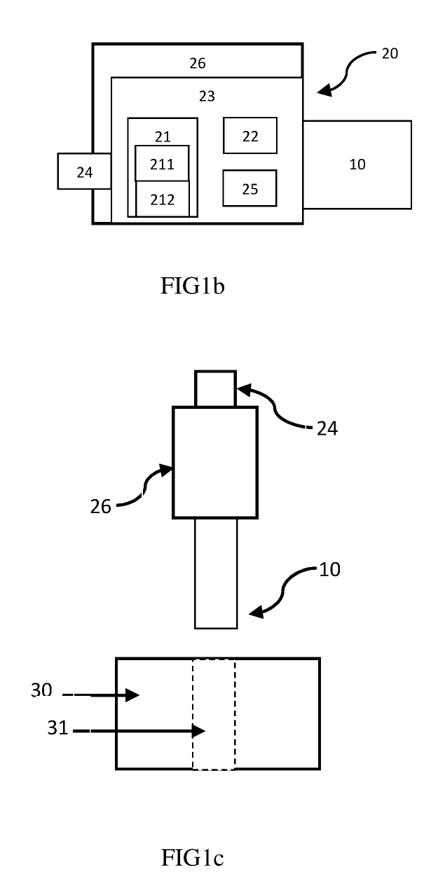

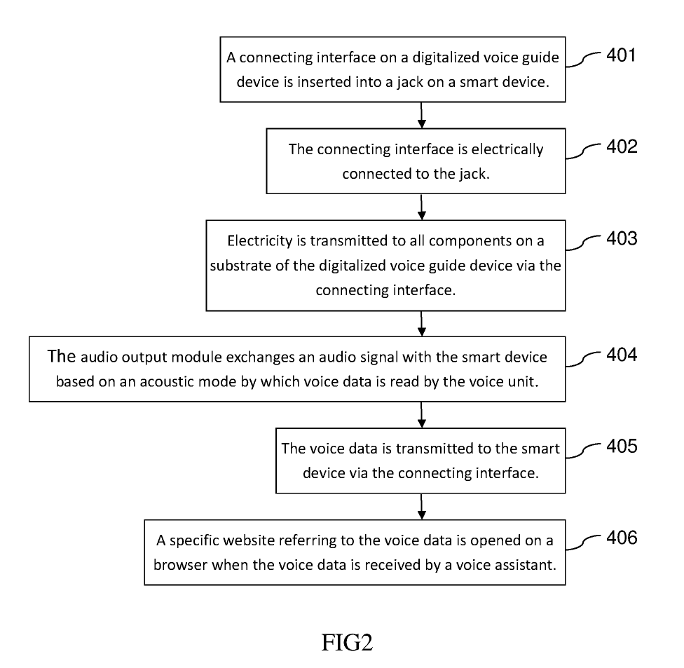

Referring to FIGS. 1a to 4, which illustrate a digitalized voice guide device and a method thereof in embodiments. As shown in FIG. 2, a digitalized voice guide device in the present disclosure comprises a connecting interface (10) and an audio output module (20).

In a digitalized voice guide device, the connecting interface (10) is a USB (Universal Serial Bus) interface or a Lightning interface: a USB interface is based on the serial bus standard for connecting a computer system to an external device and technical specifications for input/output interfaces and extensively used in IT and communications products such as personal computers and mobile devices in which Micro USB ports are common mostly; a Lightning interface based on specific connector specifications defined by Apple and including 8 metal pins is inserted either face up or face down and similar to a Micro USB connector in size as well as available to mobile devices dominated by Apple.

In a digitalized voice guide device as shown in FIG. 1a, the audio output module (20) comprises a storage unit (21), a voice unit (22), and a substrate (23) on which the storage unit (21) and the voice unit (22) are mounted; the storage unit (21) stores voice data (211).

Specifically, as shown in FIG. 1c, the connecting interface (10) is electrically connected to a smart device (30) through a jack (31) on the smart device (30) for power delivery and signal exchange through which digital audio data is transmitted to the smart device (30).

Furthermore, the storage unit (21) means nonvolatile memories saving data which is inerasable with power disconnected but readable with power resumed; the voice unit (22) means a processor, for example, micro processor (μP) which is a specific programmable IC; the substrate (23) is a printed circuit board which is an important electronic subassembly to support and connect electronic components.

Preferably, as shown in FIG. 1b, the audio output module (20) comprises a switch (24) and a simulative keyboard unit (25), both of which are installed on the substrate (23); the switch (24) controls the voice unit (22) to supply a digital audio signal to other electronic components; the simulative keyboard unit (25) is used to communicate with the smart device (30) for signal exchange between the connecting interface (10) and the smart device (30); the storage unit (21) stores input data (212) to be entered with the simulative keyboard unit (25); the audio output module (20) comprises a housing (26) which shields a digitalized voice guide device.

Referring to FIG. 2, which illustrates steps to operate a digitalized voice guide device as follows: step 1 (401): a connecting interface (10) on a digitalized voice guide device is inserted into a jack (31) on a smart device (30) for physical contact, as shown in FIG. 1c; step 2 (402): the connecting interface (10) on a digitalized voice guide device is electrically connected to the jack (31) on the smart device (30); step 3 (403): all electronic components are electrically activated when electricity is transmitted to the components on a substrate (23) of a digitalized voice guide device via the connecting interface (10); step 4 (404): the audio output module (20), which is electrically activated, exchanges an audio signal with the smart device (30) when voice data (211) from a storage unit (21) of the audio output module (20) is read by the voice unit (22) of the audio output module (20); step 5 (405): the voice data (211) is transmitted to the smart device (30) via the connecting interface (10); step 6 (406): a specific website referring to the voice data (211) is opened on a browser of the smart device (30) when the voice data (211) is received by a voice assistant in the smart device (30).

In these steps, the connecting interface (10) in step 1 (401), step 2 (402) and step 3 (403) is a USB (Universal Serial Bus) interface or a Lightning interface particularly through which electricity from the smart device (30) is supplied in step 2 (402) and step 3 (403) and the voice data (211) from the audio output module (20) to the smart device (30) is transmitted in step 4 (404) and step 5 (405).

In step 4 (404), the voice unit (22) and the storage unit (21) on the substrate (23) are activated with electricity received in step 3 (403); then, the voice data (211) in the storage unit (21), which is digital data of acoustic waves or texts, is read by the voice unit (22) and further transmitted to the smart device (30).

In step 6 (406), a specific website referring to the voice data (211) received by a voice assistant in step 5 (405) is opened on a browser according to default configurations of the voice assistant. In this regard, the voice data (211) comprises some critical voice instructions such as “Open” and “URL” (e.g., www.yahooo.com) requested by the voice assistant.

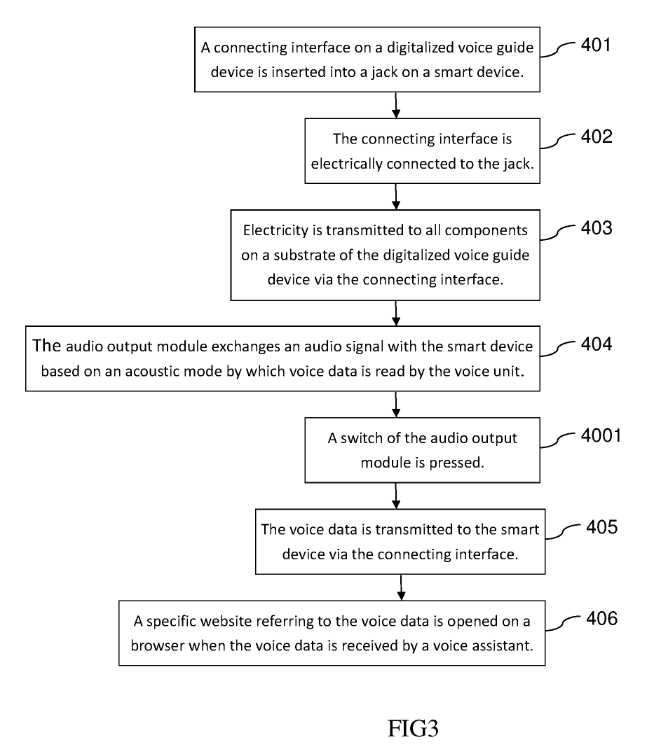

Preferably, step 4-1 (4001) is added after step 4 (404), as shown in FIG. 3. In step 4-1 (4001), a switch (24) on the audio output module (20) is pressed so that the voice data (211) is transmitted from the connecting interface. The additional step 4-1 (4001) allows a user to trigger a digitalized voice guide device in the present disclosure and prevent the digitalized voice guide device from self-running without permission.

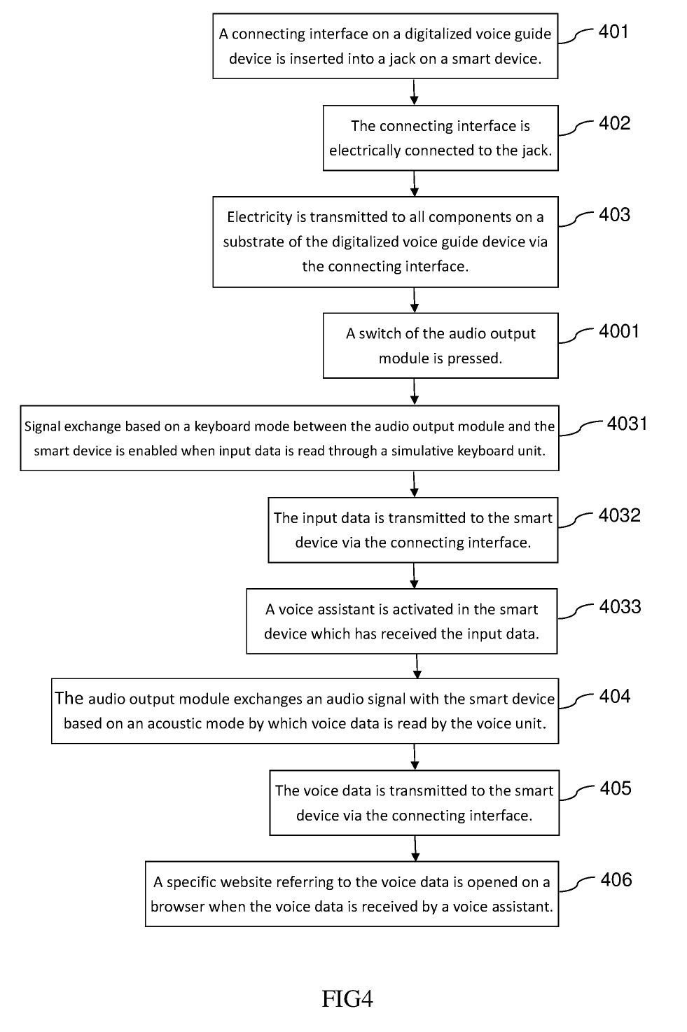

Alternatively, referring to FIG. 4, which illustrates a flowchart to prevent the case of a voice assistant not activated acoustically. In FIG. 4, step 3-1 (4031), step 3-2 (4032) and step 3-3 (4033) are added between step 4-1 (4001) and step 4 (404) in FIG. 3.

First of all, step 3-1 (4031) for signal exchange based on a keyboard mode between the audio output module (20) and the smart device (30) after the procedure from step 1 (401) to step 4-1 (4001) is enabled when input data (212) in a storage unit (21) of the audio output module (20) is read through a simulative keyboard unit (25) of the audio output module (20).

Secondly, step 3-2 (4032) is to transmit the input data (212) to the smart device (30) via the connecting interface (20).

Thirdly, step 3-3 (4033) is to activate a voice assistant in the smart device (30) which has received the input data (212).

A practical procedure to clearly present a voice guide device and a method thereof is particularly shown as follows.

In step 1 (401) in FIG. 4, a connecting interface (10) on a digitalized voice guide device as shown in FIG. 1c is inserted into a jack (31) on a smart device (30).

In step 2 (402) in FIG. 4 after step 1 (401), the connecting interface (10) is electrically connected to the jack (31) on the smart device (30) with metal contacts on both components physically touching each other.

In step 3 (403) in FIG. 4 after step 2 (402), all electronic components mounted on a substrate (23) of a digitalized voice guide device, as shown in FIG. 1b, are electrically activated.

In step 4-1 (4001) in FIG. 4, a switch (24) on the audio output module (20) is pressed so that a next step is enabled by a digitalized voice guide device.

In step 3-1 (4031), signal exchange based on a keyboard mode between the audio output module (20) and the smart device (30) is enabled when input data (212) in a storage unit (21) of the audio output module (20) is read through a simulative keyboard unit (25) of the audio output module (20).

In step 3-2 (4032), the input data (212) is transmitted to the smart device (30) via the connecting interface (20).

In step 3-3 (4033), a voice assistant in the smart device (30) which has received the input data (212) is activated without the case of a voice assistant not activated acoustically.

In step 4 (404), signal exchange between a digitalized voice guide device and the smart device (30) in which a voice assistant is activated in step 3-3 (403) based on an acoustic mode transformed from a keyboard mode is enabled when voice data (211), which is digital data of acoustic waves or texts, in a storage unit (21) is read by the voice unit (22).

In step 5 (405), the voice data (211) received in step 4 (404) is transmitted to and received by the smart device (30) via the connecting interface (10).

In step 6 (406), a specific website referring to the voice data (211) received by a voice assistant in step 5 (405) is opened on a browser according to default configurations of the voice assistant.

Accordingly, a digitalized voice guide device differing from conventional guide devices and referred to as creative work in applications of an audio signal terminal technique meets patentability and is applied for the patent.

It should be reiterated that the above descriptions present the preferred embodiment, and any equivalent change in specifications, claims, or drawings still belongs to the technical field within the present disclosure with reference to claims hereinafter.

What is claimed is:

1. A digitalized voice guide device, comprising a connecting interface (10) and an audio output module (20):
the audio output module (20) comprising a storage unit (21) and a voice unit;
the connecting interface (10), the storage unit (21) and the voice unit (22) mounted on a substrate (23);
the storage unit (21) comprising a voice data (211);
a digitalized voice guide device characterized that: the connecting interface (10) is electrically connected to a jack (31) on a smart device (30) through which all electronic components on the substrate (23) are electrically activated; the voice unit (22) communicates with the smart device (30) for signal exchange based on an acoustic mode by which voice data (211) read by the voice unit (22) is transmitted to the smart device (30) through the connecting interface (10).

2. A digitalized voice guide device as claimed in claim 1 wherein the connecting interface (10) is either a USB interface or a Lightning interface.

3. A digitalized voice guide device as claimed in claim 1 wherein the audio output module (20) comprises a switch (24) mounted on the substrate (23).

4. A digitalized voice guide device as claimed in claim 1 wherein the audio output module (20) comprises a simulative keyboard unit (25) installed on the substrate (23).

5. A digitalized voice guide device as claimed in claim 1 wherein the storage unit (21) stores input data (212).

6. A digitalized voice guide device as claimed in claim 1 wherein the audio output module (20) comprises a housing (26).

7. A method of a digitalized voice guide device with steps as follows:
step 1 (401): a connecting interface of a digitalized voice guide device is inserted into a smart device's jack;
step 2 (402): the connecting interface is electrically connected to the jack;
step 3 (403): electricity is transmitted to all electronic components on the digitalized voice guide device's substrate through the connecting interface;
step 4 (404): the audio output module communicates with the smart device for signal exchange based on an acoustic mode through which voice data saved in the audio output module's storage unit is read by the audio output module's voice unit;
step 5 (405): the voice data is transmitted to the smart device through the connecting interface;
step 6 (406): a specific website referring to the voice data is opened on a browser of the smart device with the voice data received by the smart device's voice assistant.

8. A method of a digitalized voice guide device as claimed in claim 7 wherein the audio output module communicates with the smart device for signal exchange based on a keyboard mode through which input data saved in the audio output module's storage unit is read by the audio output module's simulative keyboard unit after step 3 (4031).

9. A method of a digitalized voice guide device as claimed in claim 8 wherein the input data is transmitted to the smart device through the connecting interface after step 3 (4032).

10. A method of a digitalized voice guide device as claimed in claim 8 wherein a voice assistant is activated in the smart device which has received the input data after step 3 (4033).

11. A method of a digitalized voice guide device as claimed in claim 7 wherein a switch of the audio output module is pressed after step 3 (4001).

12. A method of a digitalized voice guide device as claimed in claim 7 wherein the connecting interface (10) is either a USB interface or a Lightning interface.
